(19) United States
(12) Patent Application Publication
(10) Pub. No.: US 2026/0279076 A1
(43) Pub. Date: Sep. 17, 2026

(54) A DEVICE, SYSTEM, COMPUTER PROGRAM AND METHOD FOR OUTPUTTING A CONTROL SIGNAL

(71) Applicant: Sony Group Corporation, Tokyo (JP)

(72) Inventor: Piergiorgio SARTOR, Stuttgart (DE)

(73) Assignee: Sony Group Corporation, Tokyo (JP)

(21) Appl. No.: 19/167,864

(22) PCT Filed: Mar. 1, 2024
(86) PCT No.: PCT/EP2024/055383

§ 371 Date: Sep. 23, 2025

(30) Foreign Application Priority Data
Mar. 30, 2023 (EP) 23165458.3

(51) Int. Cl. G06V 20/60; G06V 10/25; G06V 10/44; G06V 10/60

(52) U.S. Cl. CPC G06V 20/60; G06V 10/25; G06V 10/44; G06V 10/60; G06V 2201/06

(57) ABSTRACT

According to embodiments of the disclosure, there is provided a device comprising: processing circuitry configured to: receive a plurality of polarised light images of an object made at least in part from a polarising material, the polarising material being glass or PET plastic, wherein each of the plurality of polarised light images has a different polarisation; calculate a degree of polarisation associated with the object based on the plurality of polarised light images; determine, based on the degree of polarisation, whether the polarising material is glass or PET plastic; and output a control signal indicating the result of the determination.

### BACKGROUND

### Field of the Disclosure

The present technique relates to a device, system, computer program and method for outputting a control signal.

### Description of the Related Art

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present technique.

Plastic and glass are widely used materials in modern society. In many instances, plastic and glass products are manufactured from recycled materials. That is, many plastic products are manufactured from recycled plastic which is plastic that has been used in a product before, and many glass products are manufactured from recycled glass which is glass that has been used in a product before.

Although the manufacturing processes for many materials require use of recycled plastics, one specific example of such a material made from plastic is recycled polyester (rPET). rPET which is made from recycled Polyethylene terephthalate (PET) plastic requires 59% less energy compared to virgin polyester to manufacture and will reduce CO₂ emissions by 32% and so is becoming a popular material to make clothes from as 49% of the world's clothing is made from polyester. Typically, 9 recycled PET bottles are used to make one T-shirt.

In this production process, rPET yarn makers buy bales of recycled PET containers (such as bottles) from vendors or from recycling projects. Similarly, for the manufacture of recycled glass products, glass containers (such as bottles) are often sourced from vendors or from recycling projects.

It is common for both PET containers and glass containers to be collected in one place (for example, as part of a recycling project). It is therefore important to be able to separate PET containers and glass containers that have been collected so that they can be used in different recycling processes. If, for example, a plastic container was wrongfully included in a process for recycling glass, or if a glass container was wrongfully included in a process for recycling plastic, it would reduce the quality of the recycled material produced.

Even when it is intended for containers made of different materials to be collected separately, there are often instances where the containers are categorised incorrectly by accident. Moreover, manually sorting containers after they have been collected is time-consuming and has an increased risk of error. There is therefore a need to make the sorting process more efficient and reliable.

It is an aim of the present disclosure to distinguish between PET and glass containers to achieve the goal of sorting such containers in an efficient and reliable manner.

### SUMMARY

According to embodiments of the disclosure, there is provided a device comprising processing circuitry configured to: receive a plurality of polarised light images of an object made at least in part from a polarising material, the polarising material being glass or PET plastic, wherein each of the plurality of polarised light images has a different polarisation; calculate a degree of polarisation associated with the object based on the plurality of polarised light images; determine, based on the degree of polarisation, whether the polarising material is glass or PET plastic; and output a control signal indicating the result of the determination.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows a manufacturing process for recycled polyester;

FIG. 2 shows a system according to embodiments of the disclosure;

FIG. 3 shows a device according to embodiments of the disclosure;

FIG. 4 shows the Field of View requirements for the lens used with the image sensor according to embodiments;

FIG. 5 shows the arrangement of the light source in the system according to embodiments;

FIG. 6 shows the captured image when the angle between the light source and the object and the image sensor and the object is in the arrange of 55° and 70° and the effect of including a second light source located above the object;

FIG. 7 shows edge detection with various finishes on the interior of the housing;

FIG. 8 shows a captured image using a single light source and a second light source;

FIG. 9 shows a flow chart according to embodiments of the disclosure;

FIG. 10 shows a ground truth outline and a ground truth mask and predicted outlines and masks according to embodiments;

FIG. 11 shows a flowchart 1100 of the operation of the device 200 according to embodiments;

FIG. 12 shows images of glass and PET objects in embodiments;

FIG. 13 shows two graphs with mean degree of polarisation values calculated for images of glass and PET objects in embodiments;

FIG. 14 is a graph showing the results of a principle component analysis performed for images of glass and PET objects in embodiments;

FIGS. 15 and 16 show training results when a deep neural network is trained on data from images of known objects in embodiments;

FIGS. 17 and 18 show DNN latent space and classification results obtained using training data in embodiments; and

FIG. 19 shows an application of embodiments of the disclosure to check the ratio of the virgin plastic to recycled plastic

### DESCRIPTION OF THE EMBODIMENTS

Referring now to the drawings, wherein like reference numerals designate identical or corresponding parts throughout the several views.

Numerous modifications and variations of the present disclosure are possible in light of the above teachings. It is therefore to be understood that within the scope of the appended claims, the disclosure may be practiced otherwise than as specifically described herein.

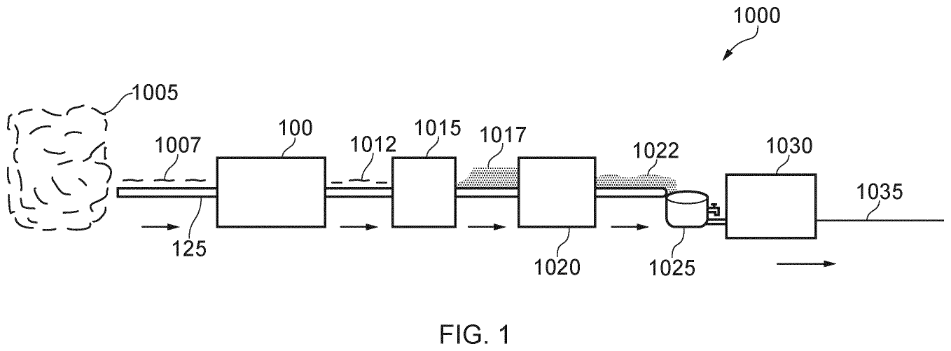

Referring to FIG. 1, a manufacturing process for recycled polyester is described. A bale of recycled material 1005 is delivered to the manufacturing plant. In embodiments, the recycled material 1005 is Polyethylene terephthalate (PET) plastic. This PET material may be provided in the form of objects such as bottles and other PET containers. Obviously, other transparent material is envisaged (such as glass) and the disclosure is not so limited.

The material is separated and placed on a conveyor belt 125. This separation may be achieved using a vibrating plate or the like upon which the bale is placed. In other instances, a person may load the material onto the conveyor belt 125 manually or the conveyor belt 125 may vibrate to separate the objects in the material. The material will include the PET plastic and other non-PET plastic object. In the following, an undesired object made from an undesired material will be termed a “foreign object”. The conveyor belt 125 may have a planar or shaped cross-section to allow easier transportation of the material along the conveyor belt 125. In FIG. 1, the individual objects 1007 are shown being transported along the conveyor belt 125; these individual objects 1007 will include objects made from PET and any foreign objects.

The individual objects 1007 are shown on the conveyor belt 125 in FIG. 1. The individual objects 1007 are fed into system 100 which accords to the present disclosure. The system 100 according to the present disclosure will be described later.

The system 100 is provided to determine whether each individual object 1007 is a foreign object or an object made from PET. The system 100 includes a device 200 that provides control signals indicating whether the individual object 1007 being analysed by the system 100 is an object made from PET or is a foreign object. Although the device 200 will be described later, one control signal, in embodiments, is provided to a series of compressed air nozzles (not shown) which are operated to blow any foreign objects from the conveyor belt 125 in accordance with the control signal provided by the system 100. This means only PET objects remain on the conveyor belt 125. In other words, the system 100 outputs a control signal which indicates that the individual object 1007 under test in the system 100 is an object made from PET. The control of air nozzles to blow foreign objects from a conveyor belt 125 is known. However, the generation of the control signal using the system 100 according to embodiments of the disclosure is not known.

The PET objects 1012 are fed into a cleaning shredder 1015. The cleaning shredder 1015 is configured to clean, dry and shred each of the individual PET objects 1012. The output from the cleaning shredder 1015 is PET flakes. The creation of PET flakes by the cleaning shredder 105 is known and so will not be described in any detail for brevity. These PET flakes are fed into a PET cleaning device 1020 where they are cleaned and dried again to ensure that the PET flakes are free from dirt and water to improve the quality of the recycled polyester output from the process. The PET cleaning device 1020 is known and so will not be described.

The output from the PET cleaning device 1020 is shown as cleaned PET flakes 1022 which is fed into vat 1025 where the cleaned PET flakes are melted. The molten PET is fed into spinnerets within housing 1030 to create recycled polyester yarn 1035.

It will be understood that the overall process for producing recycled polyester yarn is known. However, the features of the system 100 are not known.

In many instances, the empty container is a transparent object. This makes identification of the empty container very difficult using traditional imaging techniques. It is an aim of this disclosure to address this issue.

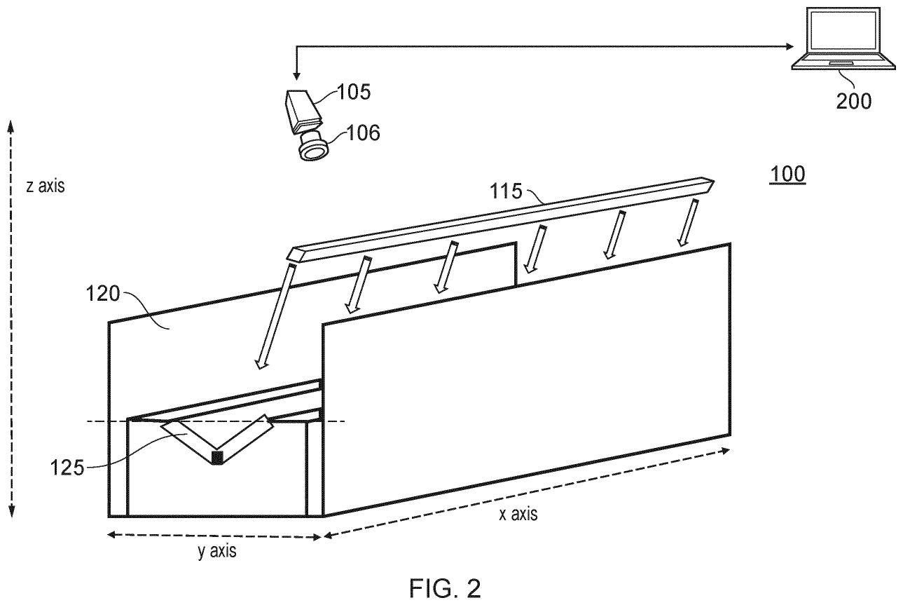

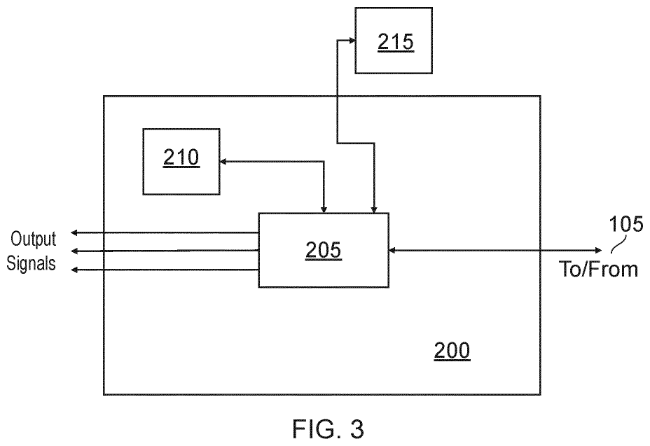

FIG. 2 shows system 100 according to embodiments of the disclosure. In the system 100, the device 200 according to embodiments of the disclosure is connected to an image sensor 105 (which may be a machine vision camera for example) and various other components of the system 100. In particular, the device 200 is, in embodiments, connected to and controls the operation of one or more light source 115 and a conveyor 125. Although the device 200 may control the components of the system 100 directly by being directly connected to the components, the disclosure is not so limited. For example, the device 200 may issue control signals to a controller (not shown) which itself controls the operation of the components of the system 100 such as the speed of the conveyor 125.

As explained above, in embodiments, the system 100 is provided in a manufacturing process for producing recycled polyester yarn, although the disclosure is not so limited and the device 200 and system 100 can be applied to any machine that detects an outline of an object at least made in part from a polarising material. In embodiments, this object may be a bottle which may be made from a transparent material such as PET. Of course, the object may have a printed label affixed thereto having branding or a bar-code or the like or may be wrapped in a film.

As is appreciated by the skilled person, the empty containers are transparent, but the disclosure is not so limited and any object made from a polarising material is envisaged. It should be noted that the disclosure is particularly advantageous in respect of transparent material as the outline of these types of objects are even more difficult to detect using RGB or monochrome image sensors as they are transparent.

These empty containers are received as a bale of material and are processed by the system 100.

If the empty container under test is accepted as being made of an appropriate material for production of the recycled material, an appropriate control signal is generated and the empty container under test passes the air nozzle. However, in the event that the empty container under test is a foreign object, an appropriate control signal is generated and the foreign object is removed from the conveyor belt 125 using a blast of air from the air nozzle.

The system 100 comprises the device 200, the image sensor 105 (which is, in embodiments a machine vision camera containing a polarisation sensor) and the light source 115. Further, the conveyor 125 is provided to transport the empty container from an opening in which the empty container is placed into the field of view of the image sensor 105. The image sensor 105 is connected to a lens 106 having a certain Field of View. This will be described in more detail later.

In embodiments, the conveyor 125 is shaped where both sides of the conveyor belt 125 move in unison to transport the empty container. The purpose of the shaped conveyor belt 125 is to centre the empty container on the conveyor 125 and allow movement of the container along the conveyor belt 125. In embodiments, the conveyor belt 125 is curved or tapered in cross section with a vertical depth suitable to hold a PET container. In other words, the distance between the horizontal plane and the bottom of the curved or tapered conveyor belt 125 in the z-direction is suitable to hold a PET container such as a bottle. This arrangement allows empty containers of many varied shapes to be transported into the machine. In addition, as many empty containers are bottles, the conveyor 125 being shaped in a curved or tapered cross-section holds the bottle and stops the bottle from moving whilst being transported.

Although the above conveyor 125 is described as being curved or tapered in cross-section, the disclosure is no way limited. For example, the conveyor 125 may be flat or inclined and made of a sticky material that grips the empty container to allow it to move through the processing steps. In embodiments, no conveyor is required and the individual empty container may be transported into the system 100 using a robotic arm or the like.

Moreover, it is envisaged that multiple objects may be processing simultaneously and thus may be provided on the conveyor 125. In fact, due to the wide field of view of the lens 106, it is possible for a plurality of objects to be captured in the same image. This allows a greater throughput of object processing. These objects may be separated or may overlap one another on the conveyor 125. In the embodiments where the objects are separated on the conveyor 125, the plurality of objects are identified and processed individually. However, in the instance where there are overlapping objects, the top object (i.e. the one closest the image sensor 105) would be correctly identified and the other object(s) would be partially obscured. However, the partially obscured outline and mask may be matched with ground truth versions in order to identify the partially obscured object(s).

In the event that one object is made of first material (such as PET) and the second object is made from a second material (such as glass), the refractive index of each material is different and so outline of the correct material is improved compared with the other material.

In embodiments, the conveyor 125 moves at speed according to the required throughput of the application. This is formulated from a combination of object length, lens field of view, capture frame rate and camera exposure time. This results in at least one complete captured view of the object with a small amount of image blur. In addition, in embodiments, the conveyor belt 125 is made from plastic or rubber so that it may be cleaned periodically. This is because the empty containers are likely to have some remnants of its contents which may spill during transportation. Therefore, it is desirable for the conveyor 125 to be cleaned to reduce the risk of malfunction during use.

In embodiments, the light source 115 is located above the conveyor 125. In particular, the light source 115 is located above the horizontal plane of the conveyor 125. The height of the light source 115 above the horizontal plane of the conveyor 125 is such that the entire object is illuminated, thus allowing the empty container to be illuminated during its processing. This improves the accuracy of the processing results. The light source 115 will be explained in more detail later. However, in embodiments, the light source 115 extends along the length of the conveyor belt 125.

In embodiments, the empty container is provided into a housing 120 during its processing. Specifically, the empty container enters through the opening (not shown) and is carried into the housing 120 by the conveyor 125 for processing. Once processed, the empty container is passed out of the housing 120 where it continues along the conveyor belt into the cleaning shredder 1015. The housing 120 is large enough so that the empty container under test sits within the curve or tapered cross-section and still be within the housing 120.

The dimensions of the housing should be selected to accommodate empty containers of varying sizes. For example, the housing may be long enough (in the x direction) to accommodate an empty container. For example, the housing 120 may be long enough to accommodate an empty 2 L PET bottle. In addition, the conveyor belt 125 within the housing 120 should be long enough to allow for a small overlap of the container at the ends of the conveyor 125. The width of the housing is approximately twice width of the empty container. The conveyor belt 125 extends the length of the housing 120. Of course, the disclosure is not so limited and the housing and conveyor 125 can be any size.

In embodiments, the image sensor 105 is located above the conveyor 125. Specifically, the image sensor 105 is located at a height above the horizontal plane of the conveyor belt 125 to allow the lens to capture the object under test. Additionally, in embodiments, the image sensor 105 is positioned to be equidistant along the conveyor 125. The positioning of the image sensor 105 is such that an image containing the entire interior of the housing may be captured. This requires a wide Field of View lens 106 to be used in embodiments as will be explained later. In embodiments, this wide Field of View lens 106 is a fish-eye lens.

The image sensor 105 captures a polarised light image. Specifically, image sensor 105 is a polarised light image sensor and captures a polarised light image of the empty container (which is one example of a transparent object). Any sensor that can capture a polarised light image is envisaged.

Referring to FIG. 2, the device 200 according to embodiments of the disclosure is shown. In embodiments, the device 200 is a computer. However, the disclosure is not so limited and the device 200 can be any device that is capable of processing information and issuing control signals such as an Application Specific Integrated circuitry (ASIC) based on input information. The device 200 comprises processing circuitry 205 that may be any kind of circuitry capable of operating using computer readable instructions to perform a method according to embodiments of the disclosure and may be a single piece of circuitry or may be multiple pieces of circuitry. The processing circuitry 205 receives images from the image sensor 105. In addition, the processing circuitry 205 sends control signals to the image sensor 105 as will become apparent later.

The processing circuitry 205 is connected to storage 210. In embodiments, the storage 210 is comprised in the device 200, although the disclosure is not so limited and the storage 210 may be located remotely to the device 200. In embodiments, the storage 210 is solid-state storage, although the disclosure is not so limited and may be magnetically or optically readable storage.

In addition, the processing circuitry 205 is connected to a database 215 of ground-truth data for known empty containers. This ground truth data is used to train a model to enable the processing circuitry 205 to detect any container made from a polarising material. These allow the device 200 to make an approve or reject decision. In embodiments, an approve decision will allow the object under test to pass through to the cleaning shredder 1015 and a reject decision will mean that the object under test is a foreign object and will be blown from the conveyor belt 125 using the air nozzle so that it does not proceed to the cleaning shredder 1015.

In this instance, the ground truth data will be provided to a Neural Network Training Controller which will supply trained weights to the processing circuitry 205 so that a decision may be made to either approve or reject the empty container under test. In embodiments, the processing circuitry 205 uses a Neural Network to decide whether an empty container should be approved or rejected and to provide a representation of the shape and dimensions of the empty container. The Neural Network weights are generated by the Neural Network Training Controller using ground-truth data of known containers and outlines. Each ground-truth data entry comprises image, ground-truth outline and classification. Outline and optionally classification can determine empty container approval or rejection.

The ground-truth data may be supplied and maintained by the manufacturer of the system 100 or the overall process or by a third party. In some embodiments, the Neural Network Training Controller may retrain the Neural Network and generate new weights periodically. In embodiments, the retraining may take place so that new bottles or objects may be detected. For example, the retraining may take place with numerous images of different types and/or shapes of glass bottles being used as the training data. In instances re-training may occur when the manufacturing process is changed maybe into a different region where other (different) types of empty containers may be present or even if the ingress of ambient light into the manufacturing process changes or even if the supplier of the bales of material changes. In embodiments, though, a short exposure time of around 1/100^{th} of a frame is used to reduce the effect of ambient light ingress. In some embodiments the Neural Network may be trained with a set of weights that take into account different or expected amounts of ambient light to which the image sensor 105 is or is likely to be exposed.

The processing circuitry 205 generates a number of output control signals. These output control signals control the various parts of the system explained in reference to FIG. 1 and provides an output signal indicating whether the empty container is to be approved to be provided to later parts of the manufacturing process or not. In embodiments, these output control signals interface with any controllers already present in the manufacturing process such as the air blower to control the various components of the manufacturing process as explained above.

### Lens 106

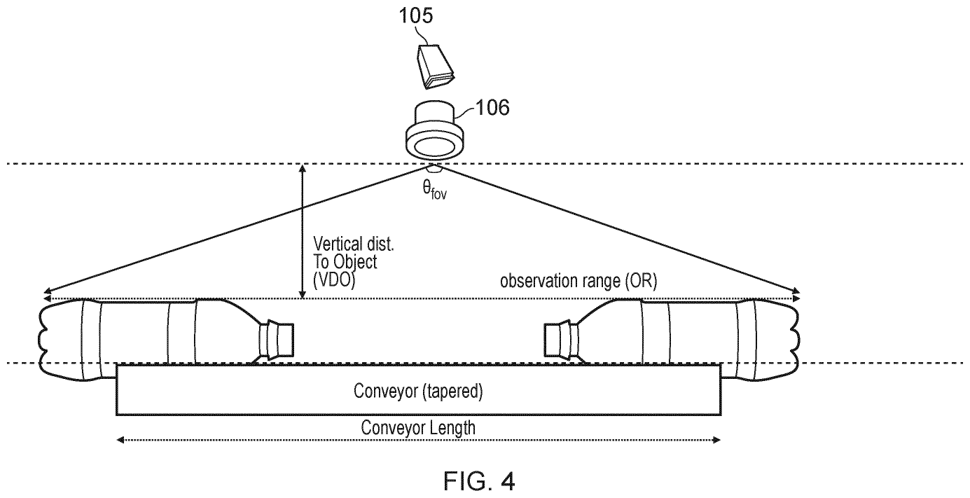

As noted above, the lens used with the image sensor 105 needs careful selection to ensure the Field of View requirements are met. FIG. 4 shows the Field of View requirements for the lens used with the image sensor according to embodiments. Of course, it will be appreciated that the Field of View requirements may change depending upon the dimensions of the object recognition system hardware in the recycled polyester manufacturing process.

The image sensor 105 is coupled to the lens 106. In embodiments, it is desirable to have a small vertical distance between the conveyor 125 and the lens 106. This is to minimise the overall height of the system 100. In embodiments, the minimum vertical distance between the conveyor 125 and the lens 106 is sufficient to allow a transparent object having a certain diameter to be processed by the system 100. In other words, the minimum vertical distance between the conveyor belt 125 and the lens 106 is sufficient to allow a transparent object under test to be processed by the system 100.

In addition, by providing the image sensor 105 and lens 106 above the object, detection of narrow-necked bottles is improved as the full-profile of the object is visible. A bottle design may be asymmetrical (for example incorporating a twist feature) and an overhead view of such a bottle may be advantageous to detect it with sufficient confidence.

It is desirable for the system 100 to begin processing the transparent object as soon as possible after insertion of the transparent object into the reverse vending machine and continue tracking the object until it passes out of the object recognition chamber onwards to further processing within the return vending machine. Accordingly, in embodiments, the observation range of the lens 106 is longer than the length of the conveyor belt 125 to allow observation of the empty container under test.

Whilst a fish-eye lens is used to provide the desired field of view, there will be fish-eye lens distortion which needs correcting using software. This type of software is commercially available and so will not be described in detail.

Of course, the maximum field of view differs depending on the geometry of the housing and specifically the value of the vertical distance to the object. Accordingly, a range of maximum field of view values in provided below in table 1 for a given vertical distance to the object.

TABLE 1
Range of Maximum Field
of View values

| VDO | θ_{fov} |
|---|---|
| (mm) | (degrees) |
| 230 | 94.8 |
| 210 | 99.9 |
| 190 | 105.5 |
| 170 | 111.6 |
| 150 | 118.1 |
| 130 | 125.1 |
| 110 | 132.5 |
| 90 | 140.4 |

The lens 106 is placed half way along the conveyor 125 and may be offset from the centre of the conveyor 125 (which is at the bottom of the taper) to reduce glare from the light source. The lens 106 may also be angled relative to the vertical to reduce glare.

In addition, the depth of field of the lens is f=4. This provides a good trade-off between the maximum amount of light entering the lens aperture (keeping the active light intensity requirement as low as possible) and achieving clear focus of the sides and top of the empty container for accurate outline detection of the empty container image.

### Light Source 115

As noted above, the system 100 comprises a light source 115. The light source 115 is used in embodiments to illuminate the empty container. This is shown in FIG. 4.

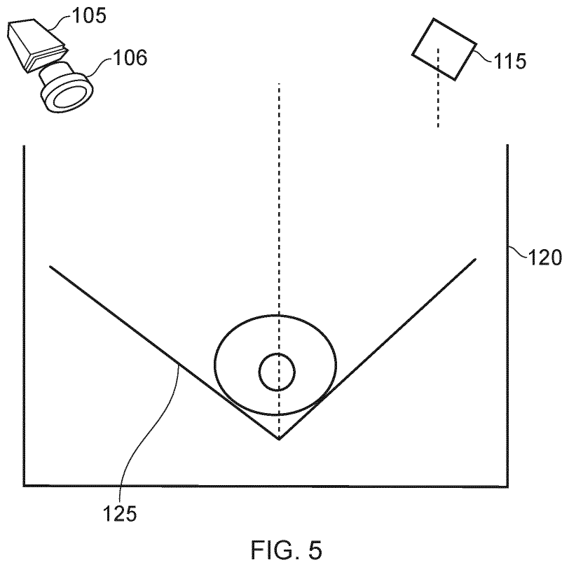

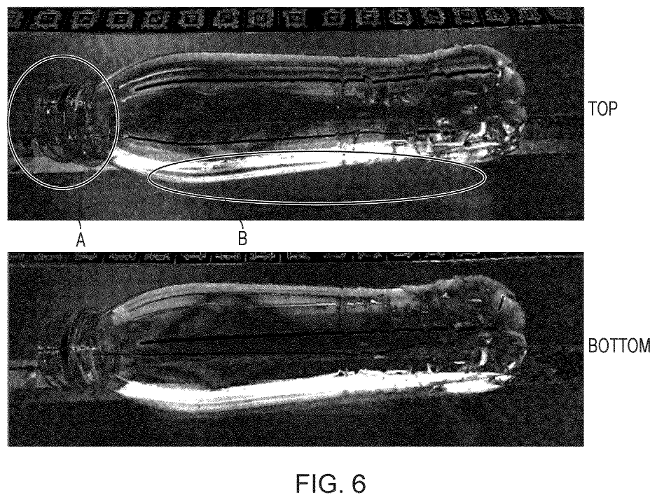

In FIG. 5, the light source 115 is positioned above the edge of the conveyor 125. An empty container (a bottle in the case of FIG. 5) is shown sat in the taper formed by the conveyor 125. The light source 115 is positioned above the edge of the conveyor 125 to illuminate the entire container. This is noted in FIG. 5.

The light source 115 has a high intensity and is an LED strip light having a warm colour temperature. The intensity of the light source 115 enables the exposure time on the image sensor 105 to be set to enable images of the transparent objects under test to be captured on the moving conveyor belt 125 with moderate (30 dB) gain and with minimal motion blur.

The light source 115 is positioned off-centre from the conveyor 125. This is noted in FIG. 5. The light source 115 is positioned at an angle to the vertical such that the light source 115 is directed to the centre of a symmetrical bottle. The light source is unpolarised.

It should be noted that although FIG. 5 shows the light source 115 being offset from the centre of the conveyor 125, the disclosure is not limited to this. In fact, in embodiments, the light source 115 may be positioned at any position relative to the centre of the conveyor 125. For example, the light source 115 may be located directly above the centre line of the conveyor 125.

In embodiments, the position of the light source 115 and the image sensor 105 may be positioned such that the angle between the image sensor 105 and the empty container (in the non-limiting case of FIG. 5, a bottle) and the light source 115 and the empty container is in the range of 55° to 70°. In particular and without limitation, the range may be any discrete angle such as 55°, 55.5°, 56°, 56.5°, 57°, 57.5°, 58°, 58.2°, 58.4°, 58.6°, 58.8°, 59°, 59.2°, 59.4°, 59.6°, 59.8°, 60°, 60.2°, 60.4°, 60.6°, 60.8°, 61°, 61.5°, 62°, 62.5°, 63°, 63.5°, 64°, 64.5°, 65°, 65.5°, 66°, 66.5°, 67°, 67.5°, 68°, 68.5°, 69°, 69.5° or 70°. This is an advantageous range as the angle between the light source 115 and the empty container increases towards the Brewster angle of the material from which the empty container is made whilst reducing the amount of space required to house the light source 115, the image sensor 105 and the empty container. This increase in the angle increases the amount of polarised light reflected from empty container. This improves the contrast in the captured outline of the empty container against the background of the housing whilst reducing the amount of space.

In the context of the empty container being polyethylene terephthalate (PET), the specific angle in this range is approximately 60° although the amount of polarised light received may vary a small amount for any given angle for different materials. This approximate angle is particularly advantageous as light from the light source 115 is incident onto the empty container is refracted into the empty container and that refracted light is reflected back out of the empty container and 60° is the angle that provides a high contrast whilst reducing the amount of space used.

As can be seen in the top image of FIG. 4, there is improved contrast in the area marked A that shows the top of the bottle and there is improved edge definition along the length of the bottle (marked B in the image).

Although the foregoing describes the angle between the image sensor 105 and the empty container and the light source 115 and the empty container is in the range of 55° to 70°, the disclosure is not limited and of course, any relative positioning of the image sensor 105, the empty container and the light source 115 is envisaged.

In embodiments, the light source may be a polarised light source. The light source may be passed through a polarising filter. The polarisation may dictate where the light source and image sensor are positioned. This may be determined experimentally. With correct positioning the light source may reinforce or amplify the polarization applied by the sensor to produce a more defined image and therefore more robust detection of the object.

In embodiments, the light source may be an infra-red light source. By using an infra-red light source, the ingress of ambient light into the system 100 and any reflections off of the object is reduced.

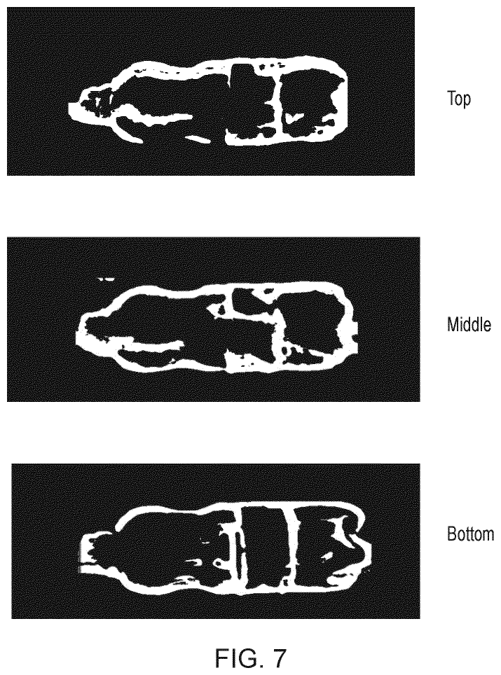

In embodiments, to improve the outline detection, the internal walls of the housing 120 in which the empty container sits whilst being imaged may have a matt finish. This is illustrated in FIG. 7. The minimisation of reflections of light generated by the background surfaces and maximisation of a uniform background appearance in the captured image improves the outline detection result.

Referring to FIG. 7, the top image shows the edge detected when the captured image is a polarised RGB image of the empty container located on a green conveyor 125 without a matt finish on the interior of the housing 120. The middle image shows the edge detected when the captured image is a polarised RGB image of the empty container located on a green conveyor 125 with a matt finish on the interior of the housing 120. Finally, the bottom image shows the edge detected when the captured image is a polarised monochrome image of the empty container located on a green conveyor 125 with a matt finish on the interior of the housing 120. As will be apparent, the matt finish on the interior of the housing 120 improves the detected edge which improves the reliability and accuracy of the system. In embodiments, the light source 115 is on when the image sensor 105 captures the polarised light image of the empty container. This may mean that the light source 115 is on permanently during the time the empty container is fed onto the conveyor 125.

In embodiments, though, the light source 115 may be on only whilst the image sensor 115 is capturing the polarised light image of the empty container. In other words, the image sensor 105 has an exposure time and the light source 115 will switch on for the exposure time as the image sensor 105 captures the image. In other words, the image sensor is configured to capture a series of images of the transparent object and the light source is configured to switch at the same frequency as the image sensor captures the series of images such that the light source is on when the image sensor captures each image in the series. This reduces energy consumption within the system 100 and mitigates the effect of sunlight on the conveyor belt 125.

It is advantageous to provide a matt finish on the interior of the housing and/or a matt finish on the conveyor to reduce the likelihood of the sensor becoming saturated or partially saturated. This avoids images to be produced with saturated pixels, for example fully white pixels which may be because of interior reflections in a transparent object. The saturation may detract from an accurate detection result or images without such clear outline as would otherwise be achieved. However, in embodiments, part of the interior of the housing or of the conveyor may include a non-matt or reflecting surface to assist in providing illumination and producing an image with sufficient dynamic range. Saturation effects can be mitigated by replacing pixels with known (optionally adjacent or spatially near) values and/or by predicting pixel values for saturated pixels.

Although the foregoing describes the system 100 having a single light source, the disclosure is not so limited. In embodiments, a second light source is provided. This second light source may or may not be the same as the first light source 115. In embodiments, the first light source is positioned at an offset to the conveyor 125 (which may mean that, in some non-limiting instances, the relative angle between the image sensor 105 and the light source 115 is the within the advantageous range of 55° to 70°) and the second light source is located directly above the centre of the conveyor 125. In this instance, the second light source, when on at the same time as the first light source, provides an increased light intensity that enables lower exposure times compared to a single light source. Moreover, whilst there are more specular reflections by having the second light source, the quality of the outline of the captured empty container remains unchanged. This is useful as the outline of the transparent object is compared with stored outlines to determine that the empty container may be accepted and processed by the manufacturing process.

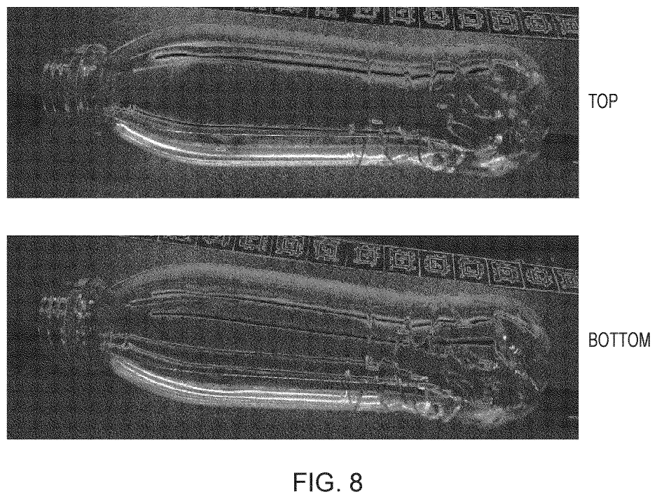

This is illustrated in FIG. 8, where the top image shows the situation with a single light source where the angle between the image sensor and the object and the light source and the object is in the range of 55° to 70° and the bottom image shows the situation with the first light source located where the angle between the image sensor and the object and the light source and the object is in the range of 55° to 70° and a second light source located above the centre of the conveyor 125. In other words, the bottom image is the same as the top image with a second light source added above the centre of the conveyor 125.

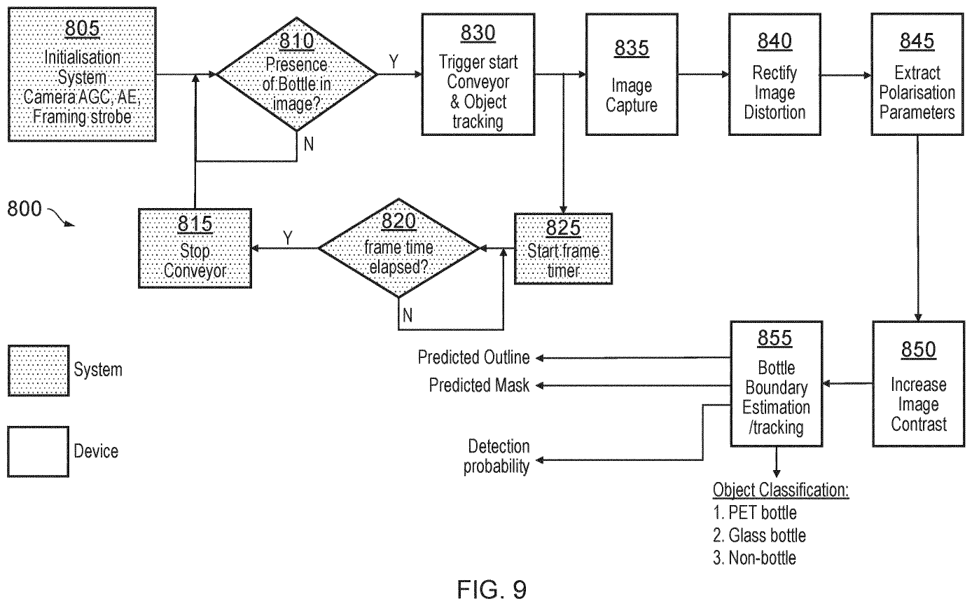

FIG. 9 shows a flowchart 800 explaining the operation of the system 100 and the device 200. The flowchart 800 is shown with sections carried out by the overall system 100 (which may be a controller of the manufacturing process) and sections carried out by the device 200 which may send control signals to the air nozzles.

The flowchart 800 commences when an object from the bales of material is detected on the conveyor 125. The process starts at step 805 where the image sensor 105 is initialised. In particular, the automatic gain control, the auto-exposure and the framing strobe of the image sensor 105 is initialised. The process moves to step 810 where it is determined if an object is located in the image captured by the image sensor 105. As the field of view of the image sensor 105 extends either side of the conveyor belt 125, the conveyor belt 125 does not need to start to detect the presence of an object (or part of an object). If there is no object captured by the image sensor 105 the no path is followed and the system waits until an object is detected. There may be a timer set so that if no object is captured within a period of time (such as 60 seconds), the system is reset.

However, if an object is captured by the image sensor 105, the “yes” path is followed to step 830. In step 830 the conveyor belt 125 is started and the object is tracked as the conveyor belt 125 moves. A frame timer is started in step 825. The duration of the frame timer is set so that at least one full image of a very large bottle can be captured within the field of view of the object recognition chamber before the conveyor starts to move the bottle out of the far side of the chamber. In embodiments, the frame timer is set to allow a particular frame rate. The process moves to step 820 to see if the frame timer has expired. If the timer has yet to expire the “no” path is followed and the conveyor 125 continues to operate. However, if the frame timer has expired, the “yes” path is followed and the conveyor 125 is stopped in step 815 and the flowchart returns to step 810.

Returning to step 830, at the same time as setting the frame timer, the image sensor 105 performs image capture in step 835. During the movement of the conveyor 125 the image sensor 835 captures an image of the empty container at its frame rate. When an image is captured the image and an image identifier (which uniquely identifies the image amongst other images) are sent to storage. This storage may be a buffer or the like which stores the image in association with the image identifier. In addition, the image and the image identifier is provided to a tracking mechanism which identifies the location of the empty container on the conveyor 125 when the image is captured.

A bounding box may be provided which surrounds the or each empty container on the conveyor 125. The tracking mechanism tracks the position of the empty container on the conveyor 125 and may store the position in association with the image and the image identifier. This allows the position of the empty container to be tracked along the conveyor 125. In embodiments, the tracking mechanism is a single pass convolutional Neural Network and, as such, has a low processing overhead.

Once the position of the empty container is determined to be optimal for the lens and light setup (for example, the empty container lay in the centre of the field of view of the lens, or that the edges of the empty container are contained within the captured image), the associated image is retrieved from the storage and this image is used in the rest of the system. In other words, the retrieved image is output from step 835.

The process then moves to step 840 where the retrieved image is rectified for barrel distortion and other imperfections caused by the wide angle lens and then corrected for sensor imperfections such as flat field and gamma correction. The process moves to step 845 where the polarisation angles of the image sensor 105 are decoded and the captured polarisation data is extracted for image enhancement. In embodiments the image sensor has 4 polarisation angles. The polarisation extraction gain is set to 6 dB and the depth of polarisation gain is set to 9 dB to enhance the image for edge detection. This processing results in an angle of polarisation image, a degree of polarisation image and an intensity image. Use of an image sensor with multiple polarisation angles or with configurably variable polarisation angles is optional but advantageous. Applying a polarisation filter to a conventional image sensor (for example a CCD or CMOS image sensor) generates only one phase angle unless a complex configurable filter is applied. The examples enable the effective real-time combination of multiple (for example four) images in different ways with different weightings to produce an improved outline image. The multiple polarisation angles can define respective Stokes parameters.

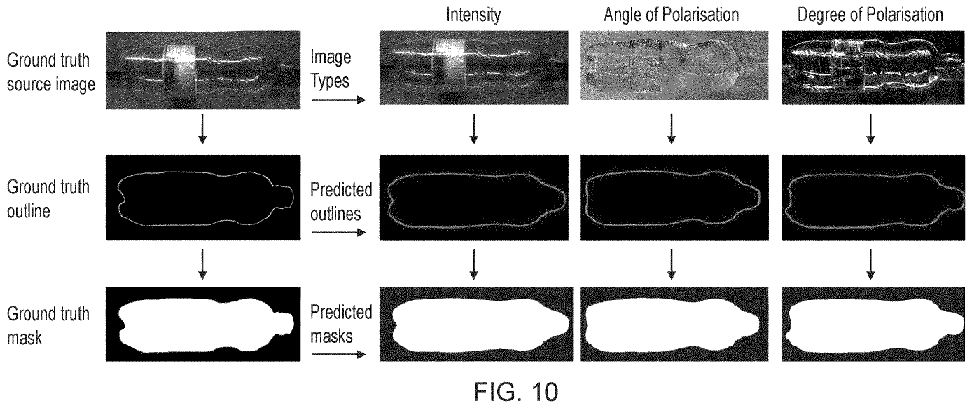

The image contrast is increased and if possible maximised in step 850. This assists in performing the outline extraction which is carried out in step 855. In particular, in step 855, three Region based Convolutional Neural Networks (RCNN) process each of the angle of polarisation image, the degree of polarisation image and the intensity image. The outputs from the three neural networks are combined to produce an optimal predicted outline of the empty container and a predicted mask of the empty container. Examples of these are shown in FIG. 10.

Additionally shown in FIG. 10 are examples of the ground truth outline and ground truth mask which are used to train the RCNN to determine the probability of the empty container under test. The use of Neural Networks permits predictions of the probability of the empty container under test notwithstanding physical distortions or partial crushing of the empty container. This is because some empty containers may be designed to have in-built material weakness such that they can be distorted by human hands to take up less space, for example for easier carrying to the recycling centres and are compacted by the recycling centres when put into bales of material. Such distortions may be a distortion to a predetermined size or shape.

In embodiments, the ground truth outline may be provided for these distorted empty containers. As will be appreciated, for the RCNN, it is necessary to provide an object classification. In embodiments, the object classification is set to be a PET bottle, a glass bottle or a non-bottle as examples of classifiable objects. The disclosure is described with respect to RCNNs, but other types of Neural Network, or combinations of types may be used.

The ground truth outlines and the ground truth masks may be provided to the device 200 by the database 215. In embodiments, the database is a training database which has many examples of different ground truth outlines and masks for any transparent object. The output of step 855 is a detection probability and a predicted outline and a predicted mask. The detection probability indicates the probability that the empty container under test is an object that is capable of being stored in the reverse vending machine. In other words, the probability that the observed object is the same class of acceptable object as defined by the ground-truth data; the Neural Network may use any features detected in the input data during this comparison. Then on the basis of the determined probability being above a threshold, output a control signal indicating a positive match. This control signal is provided to the air nozzles, and as the probability is above the threshold, the transparent object is allowed to continue in the manufacturing process. In embodiments, the device 200 may output the control signal instructing the air nozzle to accept or refuse the empty container under test into the remainder of the manufacturing process.

As will be appreciated, the Region-based Convolutional Neural Network (RCNN) has a higher processing overhead than the single-pass convolutional neural network used in the tracking mechanism. The combination of the single-pass convolutional neural network for the empty container tracking and the Region-based Convolutional Neural Network (RCNN) for the outline detection system means that a high number of images may be captured by the system, but the same accurate information is provided. In the event that only the RCNN was used, the frame rate is limited by the RCNN. Accordingly, a frame rate of around 5-6% of that for a combination of single-pass convolutional neural network and RCNN would be typical for a system where only the RCNN was provided. Therefore, in embodiments, it is advantageous to have an object detection device comprising processing circuitry configured to: receive a polarised light image of an object at least in part made from polarising material; detect the position of the object using a single pass convolutional network; detect the outline of the object from the polarised image when the object is in a predetermined position; determine the probability that the outline of the object is a stored outline using a region-based convolutional Neural Network; and on the basis of the determined probability being above a threshold; output a control signal indicating a detected object.

In embodiments, any extracted features (including, but not limited to shape and dimensions) of the predicted outline are used to determine whether the empty container under test should be accepted by the manufacturing process. This ensures only the correct type of container made from appropriate material and size is accepted in the manufacturing process. Additionally, in embodiments, it is possible to detect objects that are crushed or in some way deformed and to not accept those.

In embodiments, the input image, predicted outline, predicted mask and the predicted classification may be stored for quality control purposes. In tests, the predicted outline has a mean average accuracy of 1 mm compared to the ground truth outline. This results in 100% correct detection of a bottle in over 1000 images.

In embodiments, as has been described, some objects may have intricate design features, such as bottles with narrow necks or bottles with asymmetrical design features, or indeed intricate lids. Such features may be wholly or in part obscured from the sensor's view. Accordingly ground truth outline and masks may be partitioned into more than one component, such as a base part and a neck part of a bottle or a bottle part and a lid part, or for that matter three or more parts. In other words, the object has a first part and a second part, and the processing circuitry is configured to receive the polarised light image of the first part and at least part of the second part. For a positive detection and statistically significant of a whole object, it may be sufficient for a part to be detected with respect to the partitioned mask and that at least an adjoining, continuous part is detected, even if the adjoining, continuous part does not match the whole of another mask. In this way it should not be possible to detect, for example, more than one bottle from a bottle that has been cut in two or more pieces, but should still detect and object where parts or extremities have been obscured. This is advantageous as it increases the likelihood of correctly identifying the object.

Although the foregoing describes an object being made completely from a polarising material (that is a material that reflects or emits polarised light), the disclosure is not so limited. In embodiments, only at least a part of the object should be made from a polarising material as would be appreciated by the skilled person.

In general, the disclosure has the following steps. Firstly, a device comprising: processing circuitry configured to: receive a polarised light image of an object at least in part made from polarising material. Then the processing circuitry is configured to detect the outline of the object from the polarised image. The probability that the outline of the object is a stored outline is determined. Finally, on the basis of the determined probability being above a threshold a control signal indicating a positive match is output.

### Discrimination of Glass and PET Objects

In the embodiments described above, the system 100 and device 200 are provided to determine whether an individual object (such as a container, e.g. a bottle) is a foreign object or an object made from PET. In further embodiments of the disclosure, the system 100 and device 200 are configured to classify the material of an object by identifying whether the object is made from PET plastic or glass. In these embodiments, the device 200 produces control signals indicating whether the object being analysed by the system 100 is an object made from PET or is an object made from glass. This material classification may be carried out independently from the processes already described, or in addition. This is discussed in more detail below.

In some embodiments, a control signal produced by the device 200 is provided to a series of compressed air nozzles which are operated to blow any glass objects from the conveyor belt 125 in accordance with the control signal. This means only PET objects remain on the conveyor belt 125, whilst glass objects are removed. As already discussed, it is important to be able to separate PET containers and glass containers that have been collected so that they can be used in different recycling processes, and there is a need to make the sorting process more efficient and reliable.

In existing methods of distinguishing between PET objects and glass objects, such objects are imaged in the Short Wave InfraRed (SWIR) range, with wavelengths between approximately 950 nm and 1700 nm. However, this requires a system comprising at least one SWIR camera, which are often very expensive. In embodiments of the present disclosure, only a polarisation camera is needed to distinguish between the two materials. Moreover, a single polarisation camera can be used to perform the outline detection and object classification described in previous embodiments as well as the material classification described below.

As in previous embodiments, the image sensor 105 is a polarised light image sensor that captures a polarised light image of an object (such as an empty container). Here, the image sensor 105 has multiple polarisation angles. That is, the image sensor 105 is an image sensor configured to capture multiple images with different directions of polarisation (for example, a globally exposed Sony IMX250MZR CMOS polarisation photosensitive chip may be used, which can simultaneously capture four images with polarisation angles of 0, 45, 90 and 135 degrees respectively). Many features of the system 100 and the device 200 are unchanged in these embodiments with respect to how they are described above. Details related to identical features will not be repeated.

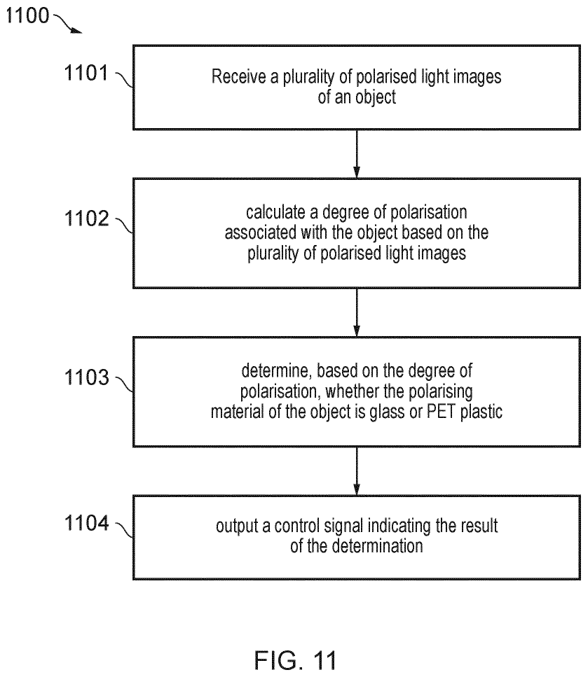

FIG. 11 shows a flowchart 1100 explaining the operation of the device 200 in performing the material classification.

In step 1101, the image sensor 105 captures a plurality of polarised light images of an object on the conveyor belt 125, wherein each of the plurality of polarised light images has a different polarisation. For example, in some embodiments the image sensor 105 captures four images of the object with polarisation angles of 0, 45, 90 and 135 degrees respectively. However, the disclosure is not limited in this regard and in other embodiments the image sensor 105 may capture any number of images with any polarisation angles, provided that at least two images are captured with different polarisation angles. The object being imaged (e.g. a bottle) may be made entirely from a polarising material, the polarising material being glass or PET plastic. However, the disclosure is not limited in this regard and in other embodiments the object may be made at least in part from glass or PET plastic but also comprise other materials. For example, a bottle may comprise an opaque lid made of another type of plastic that is not PET, and/or a label made of paper. The image sensor 105 then sends the plurality of polarised light images of the object to the device 200, and the processing circuitry 205 receives the images.

In step 1102, the device 200 calculates a degree of polarisation (p) associated with the object based on the plurality of polarised light images. The degree of polarisation is calculated, for example, using the following equation:

$$ρ = \frac{\sqrt{{( {I}_{0} - {I}_{90} )}^{2} + {( {I}_{45} - {I}_{135} )}^{2}}}{I}$$

where I₀, I₄₅, I₉₀ and I₁₃₅ are intensity values corresponding to images with polarisation angles of 0, 45, 90 and 135 degrees respectively. The value of I is the sum of (I₀+I₄₅+I₉₀+I₁₃₅) divided by 2. This means that the value of p is normalized with respect to the intensity, so that obtaining a meaningful value is not reliant on capturing images with high light intensity. The intensity of the light source 115 therefore does not need to be high.

The degree of polarisation is calculated with respect to the pixels that correspond to the object in each of the polarised images. The determination of which pixels correspond to the object may be carried out using any suitable object recognition and/or masking technique known in the art.

For example, the determination may be carried out using the processing according to embodiments of the disclosure described earlier. This is discussed in more detail below. In embodiments, the degree of polarisation associated with the object is obtained by calculating a single degree of polarisation value based on the intensity values I₀, I₄₅, I₉₀ and I₁₃₅ from every pixel that corresponds to the object. However, the disclosure is not limited in this regard. In further embodiments, the device 200 calculates an individual degree of polarisation value for each pixel and combines the individual values to obtain a final degree of polarisation associated with the object as a whole. For example, the individual degree of polarisation values calculated for each pixel may be averaged to obtain a mean degree of polarisation associated with the object as a whole. In further examples, the degree of polarisation associated with the object may be obtained from the individual pixel values by any suitable means (for example, by using a machine learning algorithm).

In step 1103, the circuitry 205 is configured to carry out a determination process to determine, based on the degree of polarisation calculated in step 1102, whether the polarising material of the object is glass or PET plastic. This determination may be achieved by use of a suitable machine learning algorithm (such as a support vector machine model, a deep neural network, a random forest learning method, or the like) that has been trained on datasets for both glass and PET objects. However, the disclosure is not limited in this regard and in other embodiments the determination may be achieved by use of any suitable analysis method (e.g. by principal component analysis).

Finally, in step 1104 the circuitry 205 outputs a control signal indicating the result of the determination. That is, the device 200 produces a control signal indicating whether the polarising material of the object is glass or PET plastic. The control signal may, for example, be provided to the above-described compressed air nozzles such that they are operated to blow an object from the conveyor belt if the determination result indicates that the object is made of glass. However, the present disclosure is not limited in this regard and in further embodiments the control signal may be provided for any purpose where the material classification is required. For example, the control signal may be provided as an input to any suitable mechanism for sorting or processing objects (such as processes for crushing, shredding, cleaning, heat-treating or the like).

Unlike other techniques used to distinguish different polarising materials, the present disclosure does not require calculating additional parameters from the polarised light images such as the refractive index of the material. The present technique requires only the degree of polarisation to be calculated, as tests have indicated that glass and PET objects can be reliably distinguished with a high degree of accuracy using only the degree of polarisation. Discriminating between glass and PET objects can therefore be achieved with a lower processing overhead in comparison to methods which require further parameters to be considered. Using only the degree of polarisation also has the advantage that, as previously explained, obtaining a meaningful value is not reliant on the use of a high intensity light source when capturing images.

However, the present disclosure is not limited in this regard. In further embodiments, the determination of whether the polarising material of the object is glass or PET plastic is additionally based on an angle of polarisation (φ) associated with the object, which is also calculated based on the plurality of polarised light images. The angle of polarisation is calculated by means of the following equation:

$$ϕ = \frac{1}{2} {arctan}_{2} ( {I}_{45} - {I}_{135} , {I}_{0} - {I}_{90} ) .$$

The angle of polarisation associated with the object as a whole can therefore be calculated with respect to the pixels that correspond to the object in each of the polarised images, in the same way as the degree of polarisation associated with the object as a whole is obtained. When additionally taking into account the angle of polarisation, the device 200 necessarily determines whether the object is glass or PET based on training data from known glass and PET objects that comprises angle of polarisation values in addition to degree of polarisation values. Whilst the material classification technique requires more processing steps in these embodiments, determination results with even higher accuracy can be achieved.

As noted above, in step 1102 the degree of polarisation is calculated with respect to pixels in each of the polarised images which correspond to the object. The determination of which pixels correspond to the object may be achieved, in some embodiments, by first performing the masking process according to earlier embodiments of the disclosure. For example, after receiving the plurality of polarised light images of an object on the conveyor belt 125, the device 200 may be configured to produce an optimal predicted outline of the object and a predicted mask of the object based on at least the degree of polarisation data from the images, using a Region based Convolutional Neural Network (RCNN) as described above. In some embodiments, polarisation data from each of the images is extracted to produce an angle of polarisation image, a degree of polarisation image and an intensity image, which are each processed by an RCNN such that the outputs can be combined to produce the optimal predicted outline and the predicted mask of the object. The degree of polarisation associated with the object is then calculated based on the area within the outline of the object (that is, the pixels corresponding to the mask of the object) in each of the polarised light images.

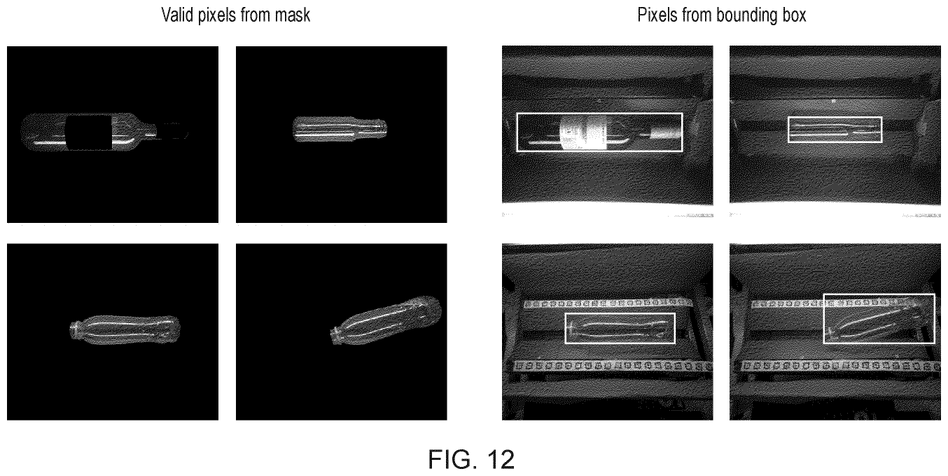

This method ensures that a high proportion of pixels from which the degree of polarisation is calculated actually correspond to the object, rather than a background section of the image (for example, a section of the image depicting the conveyor belt 125). In FIG. 12, for example, the four images on the left depict examples where pixels to be used in the calculation of the degree of polarisation are taken from within areas corresponding to object masks. It can be seen that, regardless of the shape or orientation of the object on the conveyor belt 125, there are few background pixels considered. By reducing the number of background pixels taken into account, the amount of noise in the calculation is reduced and accuracy is improved.

In further embodiments, instead of initially producing a predicted mask of the object a bounding box is provided which surrounds the object on the conveyor 125. The degree of polarisation associated with the object is then calculated based on the area within the bounding box in each of the polarised light images. The bounding box may be provided by a simple tracking mechanism such as a single pass convolutional Neural Network, which has a much lower processing overhead that the masking process. In addition, the bounding box can be provided without requiring the use of a high intensity light source when capturing images.

Since all the pixels within the bounding box are considered when calculating the degree of polarisation, the results produce a higher amount of noise due to the background pixels that do not directly correspond to the object. This is shown in FIG. 12, where the four images on the right depict examples where pixels to be used in the calculation are taken from areas of the image within bounding boxes surrounding each object. When the shape of the object deviates significantly from the shape of the bounding box (a rectangular shape shown here, although in other examples the bounding box may be any suitable shape), the number of pixels within the box that do not correspond to the object increases. This can be seen in the upper left image of the four images, in which the bounding box includes many background pixels surrounding the narrow neck of a wine bottle. In other instances, the number of pixels within the box that do not correspond to the object may be high due to the orientation of the object on the conveyor belt 125, as shown in the lower right image of the four images. Here, the bounding box includes many background pixels due to the bottle having a diagonal orientation with respect to the box.

However, the material classification technique according to the present disclosure can still reliably distinguish between glass and PET objects in embodiments where a bounding box is used to distinguish pixels to be used in the calculation of degree of polarisation.

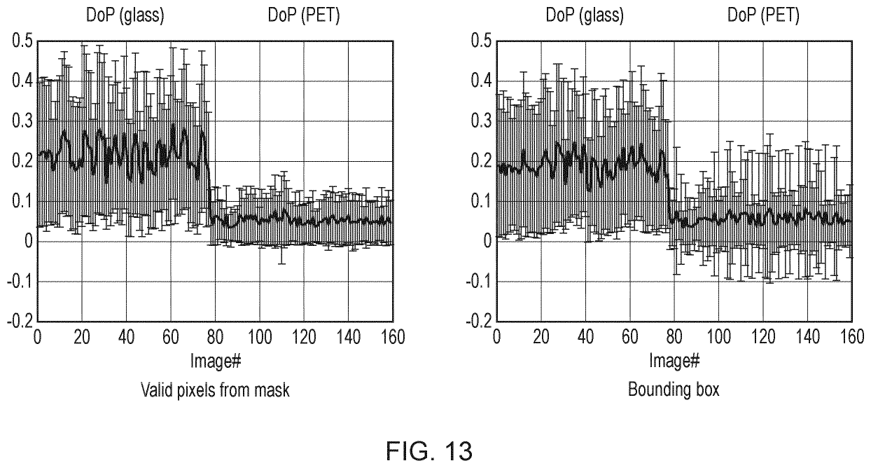

FIG. 13, for example, comprises two graphs showing mean degree of polarisation values that have been calculated for various images, and their standard deviation values represented by error bars. The graph on the left corresponds to results obtained when an object mask is used to distinguish pixels to be used in the calculation, and the graph on the right corresponds to results obtained when a bounding box is used to distinguish pixels to be used in the calculation. In each graph, there is a clear divide between mean degree of polarisation values calculated for images of glass objects (approximately the 1^{st}-75^{th} images, on the left-hand side of each graph) and images of PET objects (approximately the 75^{th}-160^{th} images, on the right-hand side of each graph). Despite the higher standard deviation values obtained with respect to the PET objects when a bounding box is used (as seen in the graph on the right), both graphs show a clear distinction between the mean degree of polarisation values calculated for glass objects and PET objects. In some embodiments, the determination of whether the polarising material of the object is glass or PET plastic is simply achieved by calculating the mean degree of polarisation for an object and comparing it to a predetermined threshold value. If the mean degree of polarisation exceeds the predetermined threshold value, it is determined that the polarising material is glass. If the mean degree of polarisation does not exceed the threshold value, it is determined that the material is PET plastic.

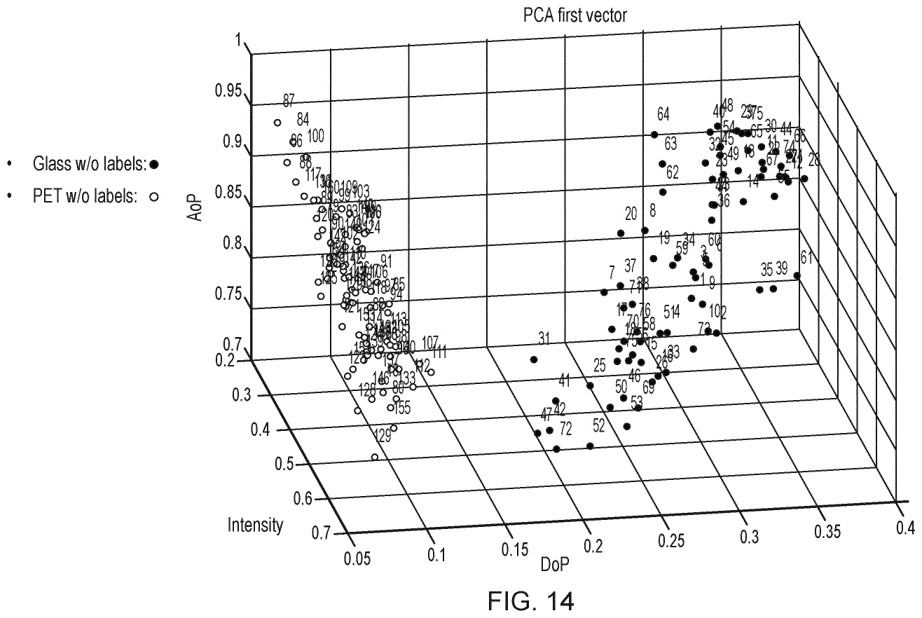

In embodiments where the degree of polarisation (ρ), the angle of polarisation (φ) and the intensity (I) associated with an object are each calculated using the methods described above, methods such as principal component analysis can be used to determine whether the object is made of glass or PET. FIG. 14 is a graph showing the results of principle component analysis performed for images of glass and PET objects. In FIG. 14 there is a clear divide between the results for PET objects (data points on the left side of the figure) and the results for glass objects (data points on the right side of the figure). The determination of whether the polarising material of the object is glass or PET plastic can therefore be achieved by comparing the degree of polarisation, the angle of polarisation and the intensity associated with an object to predetermined threshold values.

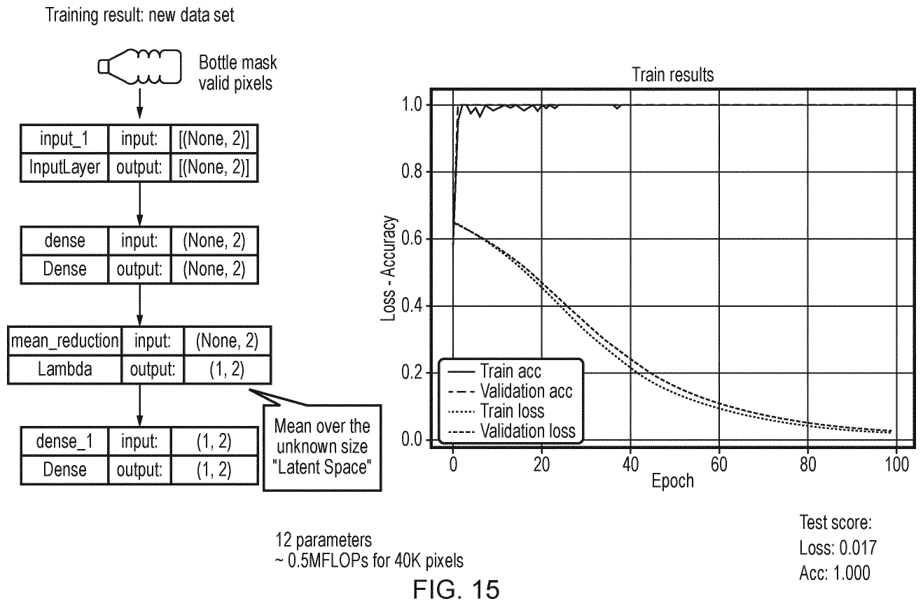

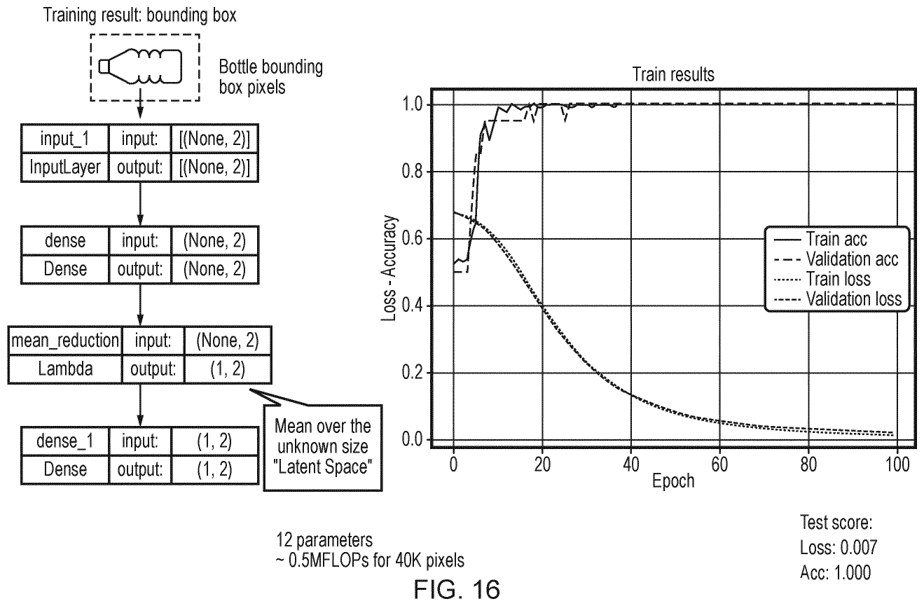

As noted above, in some embodiments the determination of whether an object is made of PET or glass is achieved by use of a suitable machine learning algorithm. FIGS. 15 and 16 show the training results when a deep neural network (DNN) is trained on data from images of known objects. FIG. 15 shows results obtained using training data from embodiments where a mask of the object is produced, and the degree of polarisation associated with the object is calculated based on the pixels corresponding to the mask of the object. FIG. 16 shows results obtained using training data from embodiments where a bounding box surrounding the object is provided, and the degree of polarisation associated with the object is calculated based on the pixels within the bounding box. In the DNN architecture depicted in FIGS. 15 and 16, values corresponding to each pixel are multiplied by a 2×2 matrix and 2 bias is added. The mean of the results is then computed, and multiplied by a second 2×2 matrix with 2 bias. The two matrices and the four bias are learned during the training process. Thus 12 parameters are used in total. However, the present disclosure is not limited in this regard and in further embodiments any suitable structure may be used.

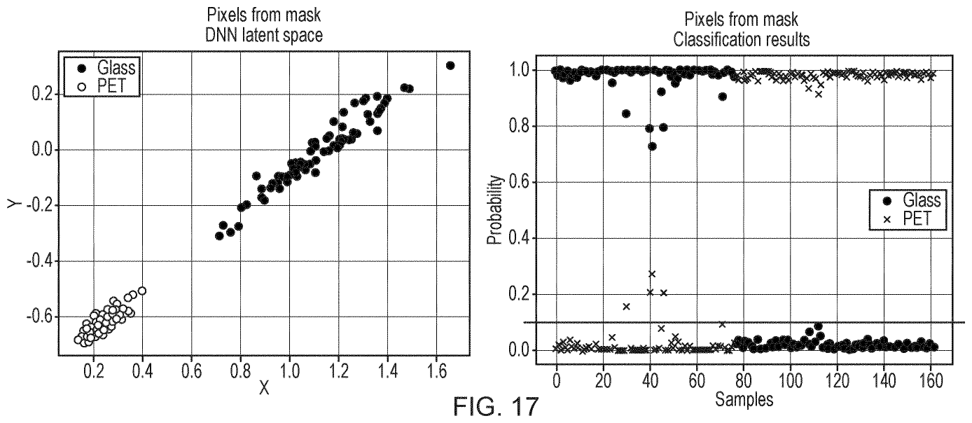

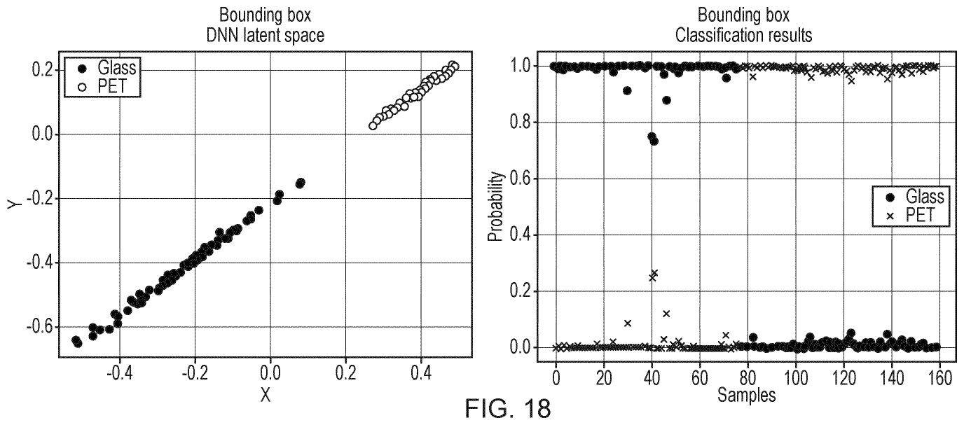

In FIG. 16 it can be seen that the training and validation accuracy take longer to reach 1.0 consistently for data obtained when a bounding box is used, due to the increased noise from background pixels. From FIGS. 17 and 18, however, it is evident that the DNN can reliably distinguish between glass objects and PET objects regardless of whether a mask is used or a bounding box is used. FIG. 17 shows DNN latent space and classification results obtained using training data from embodiments where a mask of the object is used, and FIG. 18 shows DNN latent space and classification results obtained using training data from embodiments where a bounding box surrounding the object is used. The DNN latent space plots in both cases show a significant separation between the bunched data corresponding to images of glass objects and images of PET objects respectively. The classification results both show that, out of approximately 160 samples in each case, the probability of a data point corresponding to the correct material (that is, the probability that a degree of polarisation value calculated from an image of a glass object corresponded to a glass object, or the probability that a value from an image of a PET object corresponded to a PET object) is higher than 90% for all but 3-4 samples (for which the probabilities range between 70-90%). The DNN can therefore distinguish between glass objects and PET objects reliably, both in embodiments where a mask of the object is used and in embodiments where a bounding box surrounding the object is used to distinguish pixels that correspond to the object.

In further embodiments, the device 200 is configured to initially use a bounding box to distinguish pixels that correspond to the object, but also produce a mask of the object in certain circumstances. The device 200 performs the processing to provide a bounding box in the captured images, calculates the degree of polarisation based on pixels within the bounding box, and then performs an additional determination process to identify whether the error in the result exceeds a predetermined threshold. If the error associated with the degree of polarisation does not exceed the threshold, the device determines whether the polarising material of the object is glass or PET plastic based on the degree of polarisation and outputs a control signal indicating the determination result. If, however, the error associated with the degree of polarisation exceeds the threshold (due to a high level of noise resulting from, for example, the orientation of the object being imaged), the device 200 is configured to perform processing to create the object mask as described above. The device 200 then repeats the calculation of the degree of polarisation based on pixels within the mask, and determines whether the polarising material of the object is glass or PET plastic based on the new degree of polarisation calculated. This method ensures that all degree of polarisation results used to determine the material of the object have an error below the predetermined threshold, but only requires the device to perform the processing required to produce a mask of an object when necessary.

In some embodiments of the disclosure, the device 200 is configured such that the control signal indicating the determination result (that is, whether the object being analysed is made from PET or glass) further indicates an uncertainty value associated with the determination result. This uncertainty value may be calculated in any suitable manner, depending on the determination method used. For example, in some embodiments where the DNN architecture described above is used to classify the material, the probability values that are calculated for each data point are obtained (as shown in FIGS. 17-18). If it is determined that there is a 90% probability that an object is made of glass and a 10% probability that the object is made of PET plastic, for example, the device 200 may output a control signal indicating that the object is classified as ‘glass’ with a 90% probability. In another example, in embodiments where the determination is achieved by comparing a mean degree of polarisation for an object to a predetermined threshold value (as described above with reference to FIG. 13), the uncertainty may be based on the standard deviation for the calculated mean degree of polarisation value and/or the proximity to the threshold.

By indicating an uncertainty value associated with the determination result in addition to the result itself, the control signal can be used to determine whether to process a particular object in a particular way based on the uncertainty value. In embodiments, if the uncertainty value falls within a predetermined threshold, the object may be processed in a particular way regardless of the material classification. For example, if the control signal indicates that an object is glass or PET with a probability that is below 60%, the object may be fed through the system 100 a second time so that the material classification can be performed again for the object. This would allow a more accurate determination result to be obtained the second time (e.g. if the low probability occurred due to the orientation of the object on the conveyor belt 125, changing the orientation is likely to result in a more accurate classification). In another example, an object may be sent to be manually sorted in instances where the uncertainty value associated with the determination is above a predetermined threshold.

Thus, according to embodiments of the disclosure, the system 100 and device 200 are configured to classify the material of an object by identifying whether the object is made from PET or glass.

### Further Embodiments

In addition to the embodiments being used in the sorting of containers for recycled polyester production, embodiments of the disclosure can be used in other scenarios.

As noted above, recycling centres collect PET bottles and other containers for use in production of recycled material. In many areas, consumers pay a bottle deposit when purchasing a product contained within a bottle made of a recyclable material such as PET or glass. When the consumer provides a bottle to a recycling centre, the deposit is returned to the consumer. Given the large number of products that are contained within a bottle or other container or object, some recycling schemes pay very large amounts of money to consumers in a particular year. For example, it is reported in [1] that the State of California recycling scheme pays around $1.5 Billion in bottle deposits a year. Given these high amounts of money, it is reported that more than $200 million of bottle deposits are fraudulently received by criminals.

In some instances, foreign objects are added to loads of PET containers which are collected so that a deposit is fraudulently returned for the foreign object. These foreign objects are not PET containers. By putting these foreign objects in the collected load, the deposit is provided fraudulently and, importantly for recycling, the consignment of PET containers is contaminated. Therefore, it is desirable to quickly and accurately detect instances where a person is trying to claim a deposit fraudulently.

In some regions of the world, so-called Reverse Vending Machines are provided. These are located in recycling centres and other areas where customers go to return PET containers and obtain a refund.

It is possible to install a system 100 analogous to that installed in the manufacturing process within a Reverse Vending Machine or other suitable mechanism that is used to return a deposit to a consumer.

In particular, the user may provide the container under test to the system 100 via conveyor belt 125. The device 200 within the system 100 will then issue a control signal to a controller within the Reverse Vending Machine in the event of a positive match (i.e. the object under test is a container made from the correct material such as PET). In the event of such a control signal, the Reverse Vending Machine will then carry out a known refunding technique to refund the deposit to the consumer and will store the container. In other words, in the above manufacturing process, the control signal indicating a positive match will control the use of an air nozzle to not remove the object from the manufacturing process, whereas in the Reverse Vending Machine embodiment, the control signal indicating a positive match will control the storage of the object under test and return of the deposit.

In the event of a negative comparison (i.e. the object under test is a foreign object), the device 200 will issue an appropriate control signal and the object under test will be returned to the consumer and no refund of the deposit will be given. This is analogous to the manufacturing process where a control signal indicating a negative match controls the air nozzle to blow the object under test from the conveyor belt 125.

In this embodiment, the system 100 receives each individual empty container, checks that the empty container is appropriate for the vending machine (i.e. is the correct size, made of the correct material, is weighed to avoid accepting fully or partially filled objects and is acceptable to be processed) and, where appropriate, provides a refund of any deposit paid by the consumer for the container when purchasing the original product.

In the case where a refund is provided, the device 200 (or the controller to which the device 200 provides control signals) within the system 100 confirms that the empty container is not a fraudulent attempt to receive a refund.

In order to make efficient use of the storage within the Reverse Vending Machine, the empty container is typically crushed to maximise use of space within the reverse vending machine and placed into a receptacle that is emptied periodically. The disclosure relates to the processing for accepting the empty container rather than the crushing and storing of the empty container and so this will not be described in any detail hereinafter.

In the event that the container is not accepted by the reverse vending machine, for example, it is full of liquid or is not the correct size or is in some way inappropriate for the reverse vending machine, the unaccepted container is returned to the customer. In instances an alarm may sound when the unaccepted container is returned to the customer and the customer may lose the opportunity to receive a refund for the container. Of course, in instances, the unaccepted container may be still stored in a separate container within the reverse vending machine.

In embodiments, a barcode scanner may be installed at the opening in which the customer places the empty container. The barcode scanner may look for a barcode located on the empty container. Typically, the barcode is uniquely associated with the product and thus the outline of the empty container. Therefore, if detected, the barcode is associated with the outline of a particular empty container. Accordingly, the barcode is used, in embodiments, to check that the detected outline matches the outline associated with the barcode. In the event of no match, the empty container may be rejected.

In embodiments, the weight of the empty container may be taken at the opening in which the customer places the empty container. The weight check will determine if the empty container still has its contents in it (in which case it will be rejected as not being empty). In the event that the empty container is too heavy compared to accepted empty containers, the empty container will be immediately rejected. It will be understood that many advantageous features of the device and system used in the manufacturing process may be used in the Reverse Vending Machine as such advantageous features are appropriate such as the tapered conveyor belt carrying the objects into the system.

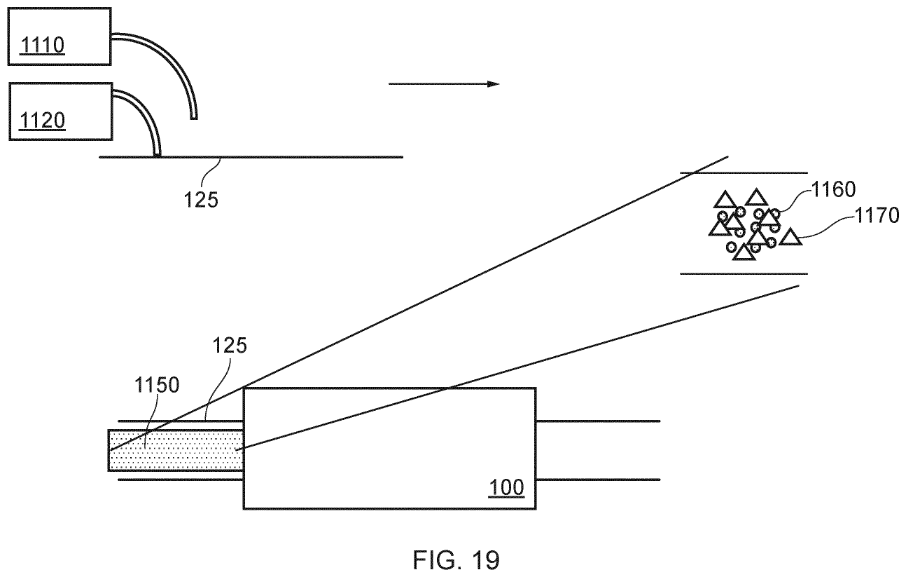

A possible further application of embodiments of the disclosure is discussed in relation to FIG. 19. In the manufacture of plastic products (such as being made using extrusion techniques), it is common to produce the plastic products from a combination of recycled plastic and virgin plastic. In many instances the ratios of virgin plastic to recycled plastic varies depending upon the application of the manufactured plastic product. For example, for plastic products that are of medical grade, there is a higher proportion of virgin plastic than for non-medical grade products. In some examples, a product vendor may be selling their product on the basis that a container is manufactured from a stated proportion or at least a stated proportion of recycled plastic.

FIG. 19 shows an application of embodiments of the disclosure to check the ratio of the virgin plastic to recycled plastic. In the upper part of FIG. 19, a first hopper 1110 and a second hopper 1120 feed plastic onto a conveyor belt 125. The first hopper 1110 contains virgin plastic beads and the second hopper 1120 contains recycled plastic flakes. In other words, the first hopper 1110 contains virgin plastic formed as beads and the second hopper 1120 contains recycled plastic formed as flakes. It should be noted here that, in embodiments, the outline of the plastic beads and the outline of the plastic flakes is different. In fact, according to embodiments, there is no restriction on the shape of each of the recycled plastic and the virgin plastic; just that the two forms of plastic have different outlines. This mixture of plastic is then fed into the plastic manufacturing process by being melted and fed into an extruder or the like.

The ratio (by weight) of the virgin plastic beads and the recycled plastic flakes is selected according to the plastic article being manufactured by the extrusion process. As noted above, articles that are made from medical grade plastic usually have higher levels of virgin plastic compared to articles made of disposable plastic which tend to have higher levels of recycled plastic. Accordingly, it is important for quality control to regularly sample the ratio of plastic virgin plastic and recycled plastic being melted and fed into the extrusion process.

In order to improve this process, the system 100 of embodiments of the disclosure is used. The plastic mix 1150 from the first hopper 1110 and the second hopper 1120 is shown in plan view at the bottom of FIG. 19. This is fed into the system 100 of embodiments of the disclosure. A close-up view of the mix is shown. As can be seen, the mix is a combination of recycled plastic flakes 1170 and virgin plastic beads 1160. As the mix passes through the system 100, embodiments of the disclosure are carried out and the outline of the constituent parts of the plastic in the mix is derived. This allows the number of plastic flakes and number of plastic beads in any one sample to be accurately counted. Accordingly, it is possible to determine if the ratio of recycled plastic to virgin plastic is correct.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

Embodiments of the present technique can generally described by the following numbered clauses:
1. A device comprising processing circuitry configured to:
   receive a plurality of polarised light images of an object made at least in part from a polarising material, the polarising material being glass or PET plastic, wherein each of the plurality of polarised light images has a different polarisation;
   calculate a degree of polarisation associated with the object based on the plurality of polarised light images;
   determine, based on the degree of polarisation, whether the polarising material is glass or PET plastic; and
   output a control signal indicating the result of the determination.
2. A device according to clause 1, wherein the circuitry is further configured to:
   provide a bounding box surrounding the object in the plurality of polarised light images; and
   calculate the degree of polarisation associated with the object based on the area within the bounding box in each of the polarised light images.
3. A device according to clause 1 or clause 2, wherein the circuitry is further configured to:
   detect an outline of the object in the plurality of polarised light images; and
   calculate the degree of polarisation associated with the object based on the area within the outline of the object in each of the polarised light images.
4. A device according to any preceding clause, wherein the circuitry is further configured to:
   calculate a phase angle associated with the object based on the plurality of polarised light images; and
   determine whether the polarising material is glass or PET plastic based on the calculated phase angle.
5. A device according to any preceding clause, wherein the circuitry is configured to determine whether the polarising material is glass or PET plastic using machine learning processing.
6. A system comprising a device according to any preceding clause, an image sensor configured to output the plurality of polarised images of the object, and a light source.
7. A method comprising:
   receiving a plurality of polarised light images of an object made at least in part from a polarising material, the polarising material being glass or PET plastic, wherein each of the plurality of polarised light images has a different polarisation;
   calculating a degree of polarisation associated with the object based on the plurality of polarised light images;
   determining, based on the degree of polarisation, whether the polarising material is glass or PET plastic; and
   outputting a control signal indicating the result of the determination.
8. A method according to clause 7, further comprising:
   providing a bounding box surrounding the object in the plurality of polarised light images; and
   calculating the degree of polarisation associated with the object based on the area within the bounding box in each of the polarised light images.
9. A method according to clause 7 or clause 8, further comprising:
   detecting an outline of the object in the plurality of polarised light images; and
   calculating the degree of polarisation associated with the object based on the area within the outline of the object in each of the polarised light images.
10. A method according to any of clauses 7 to 9, further comprising:
   calculating a phase angle associated with the object based on the plurality of polarised light images; and
   determining whether the polarising material is glass or PET plastic based on the calculated phase angle.
11. A method according to any of clauses 7 to 10, wherein the determination of whether the polarising material is glass or PET plastic is performed using machine learning processing.
12. A computer program product comprising computer readable instructions which, when loaded onto a computer, configures the computer to perform a method according to any one of clauses 7 to 11

### REFERENCE

[1] https://californiaglobe.com/environment/calrecycle-loses-200-million-a-year-due-to-bottle-deposit-fraud/

1. A device comprising processing circuitry configured to:
receive a plurality of polarised light images of an object made at least in part from a polarising material, the polarising material being glass or PET plastic, wherein each of the plurality of polarised light images has a different polarisation;
calculate a degree of polarisation associated with the object based on the plurality of polarised light images;
determine, based on the degree of polarisation, whether the polarising material is glass or PET plastic; and
output a control signal indicating the result of the determination.

2. A device according to claim 1, wherein the circuitry is further configured to:
provide a bounding box surrounding the object in the plurality of polarised light images; and
calculate the degree of polarisation associated with the object based on the area within the bounding box in each of the polarised light images.

3. A device according to claim 1, wherein the circuitry is further configured to:
detect an outline of the object in the plurality of polarised light images; and
calculate the degree of polarisation associated with the object based on the area within the outline of the object in each of the polarised light images.

4. A device according to claim 1, wherein the circuitry is further configured to:
calculate a phase angle associated with the object based on the plurality of polarised light images; and
determine whether the polarising material is glass or PET plastic based on the calculated phase angle.

5. A device according to claim 1, wherein the circuitry is configured to determine whether the polarising material is glass or PET plastic using machine learning processing.

6. A system comprising a device according to claim 1, an image sensor configured to output the plurality of polarised images of the object, and a light source.

7. A method comprising:
receiving a plurality of polarised light images of an object made at least in part from a polarising material, the polarising material being glass or PET plastic, wherein each of the plurality of polarised light images has a different polarisation;
calculating a degree of polarisation associated with the object based on the plurality of polarised light images;
determining, based on the degree of polarisation, whether the polarising material is glass or PET plastic; and
outputting a control signal indicating the result of the determination.

8. A method according to claim 7, further comprising:
providing a bounding box surrounding the object in the plurality of polarised light images; and
calculating the degree of polarisation associated with the object based on the area within the bounding box in each of the polarised light images.

9. A method according to claim 7, further comprising:
detecting an outline of the object in the plurality of polarised light images; and
calculating the degree of polarisation associated with the object based on the area within the outline of the object in each of the polarised light images.

10. A method according to claim 7, further comprising:
calculating a phase angle associated with the object based on the plurality of polarised light images; and
determining whether the polarising material is glass or PET plastic based on the calculated phase angle.

11. A method according to claim 7, wherein the determination of whether the polarising material is glass or PET plastic is performed using machine learning processing.

12. A computer program product comprising computer readable instructions which, when loaded onto a computer, configures the computer to perform a method according to claim 7.
